(19) United States
(12) Patent Application Publication
(10) Pub. No.: US 2026/0083045 A1
(43) Pub. Date: Mar. 26, 2026

(54) FORCED AIR APPLICATOR FOR DISTRIBUTION OF GRANULAR PRODUCTS

(71) Applicant: Mark & Phil's Inc., Powell, OH (US)

(72) Inventor: Mark Slavens, Draper, UT (US)

(73) Assignee: Mark & Phil's Inc., Powell, OH (US)

(21) Appl. No.: 19/336,432

(22) Filed: Sep. 22, 2025

Related U.S. Application Data
(60) Provisional application No. 63/697,265, filed on Sep. 20, 2024.

(51) Int. Cl. A01C 15/04; A01C 15/00; A01C 15/02

(52) U.S. Cl. CPC A01C 15/04; A01C 15/006; A01C 15/02

(57) ABSTRACT

Systems, methods, and devices for evenly disbursing granular products. A device includes a hopper comprising a hopper sidewall and a hopper exit hole, wherein the hopper exit hole is formed in the hopper sidewall. The device includes a flowrate adjustor plate, wherein a position of the flowrate adjustor plate relative to the hopper exit hole determines a flowrate of a product that exits the hopper. The device includes an exit tube comprising a tube sidewall and an exit hole disposed at a distal end of the exit tube, wherein the product passes through an exit interior space defined by the tube sidewall. The device includes a blower in airflow communication with the exit tube, wherein activation of the blower causes the product to be pushed through the exit tube and dispersed through the exit hole in the distal end of the exit tube.

### CROSS-REFERENCE TO RELATED APPLICATIONS

This application claims the benefit of U.S. Provisional Patent Application No. 63/697,265, filed Sep. 20, 2024 titled “FORCED AIR APPLICATOR FOR DISTRIBUTION OF GRANULAR PRODUCTS,” which is incorporated herein by reference in its entirety, including but not limited to those portions that specifically appear hereinafter, the incorporation by reference being made with the following exception: In the event that any portion of the above-referenced applications are inconsistent with this application, this application supersedes the above-referenced applications.

### TECHNICAL FIELD

The disclosure relates generally to systems, methods, and devices for evenly distributing solid granular materials.

### BACKGROUND

There are many instances where a granular product should be evenly distributed over a wide area. Exemplary granular products that are commonly distributed include, for example, granular fertilizers, ice-melt, salts, sand, dirt, turf infill, pesticides, herbicides, seeds, and so forth. Thus, numerous residential and commercial property owners need effective means for easily, efficiently, and evenly distributing granular products.

For example, many plants benefit from fertilizers and other agricultural products, such as pesticides or selective herbicides. However, current fertilizer spreaders often provide inconsistent distribution, which leads to sub-optimal plant health and inefficient use of fertilizer resources. This is particularly true as it applies to residential yard care, where agricultural products may be spread over a relatively small area.

Additionally, for example, many regions benefit from distributing salts and ice melts to reduce the accumulation of ice and/or hasten ice melting. This can be necessary in some regions of the world where severe storms can coat roads and sidewalks in ice that prevent people from driving or walking. However, current ice melt spreaders often provide uneven distribution of ice melt. This can be a waste of resources and can further cause damage to concrete or asphalt surfaces.

The process of spreading granular products can be challenging for several reasons, including, for example, the risk of uneven distribution, the difficulty of spreading different granule types with the same distribution device, and the limitations of known distribution devices for spreading granular products quickly. However, known distribution devices, such as broadcast spreaders or sprayers, can lead to inefficient application and frequently fail to evenly spread the correct amount of granular product.

What is needed are improved systems, methods, and devices for spreading granular products, such as ice melts, fertilizers, and other agricultural products. In view of the foregoing, disclosed herein are systems, methods, and devices for forced air applicators for the distribution of granular products.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings where:

FIG. 1 is a rear perspective view of a device for evenly disbursing a granular product;

FIG. 2 is a front perspective view of a device for evenly disbursing a granular product;

FIG. 3 is a side view of a device for evenly disbursing a granular product, and further illustrates direction of travel of the granular product through the device;

FIG. 4 is an opposite side view of a device for evenly disbursing a granular product, and further illustrates direction of travel of the granular product through the device;

FIG. 5 is a rear end view of a device for evenly disbursing a granular product;

FIG. 6 is a front end view of a device for evenly disbursing a granular product;

FIG. 7 is a top-down aerial view of a device for evenly disbursing a granular product, wherein a hopper lid of the device is removed;

FIG. 8 is a top-down aerial view of a device for evenly disbursing a granular product;

FIG. 9 is a bottom-up view of an underside of a device for evenly disbursing a granular product;

FIG. 10 is a cross-sectional side view of a device for evenly disbursing a granular product, and further illustrates a direction of airflow pushed by a blower of the device;

FIG. 11A is a cross-sectional side view of a portion of a device for evenly disbursing a granular product, and specifically illustrates a trigger in a relaxed position such that granular product is not permitted to exit the hopper;

FIG. 11B is a cross-sectional side view of a portion of a device for evenly disbursing a granular product, and specifically illustrates a trigger in a pulled position such that granular product is permitted to exit the hopper;

FIG. 12A is a cross-sectional aerial view of a portion of a device for evenly disbursing a granular product, and specifically illustrates wherein an adjustor mechanism permits greater flow of granular product through the hopper; and

FIG. 12B is a cross-sectional aerial view of a portion of a device for evenly disbursing a granular product, and specifically illustrates wherein an adjustor mechanism permits reduced flow of granular product through the hopper.

### DETAILED DESCRIPTION

Described herein are systems, methods, and devices for evenly distributing a granular product. The systems, methods, and devices described herein may be utilized to distribute any suitable granular product, such as, for example, fertilizer, ice melt, seeds, turf infill, herbicides, pesticides, sand, dirt, and so forth. The systems, methods, and devices described herein represent a significant improvement over granular distribution systems known in the art, which typically provide uneven and inefficient distribution of granular products.

An exemplary traditional distributor is a wheeled applicator that distributes granular product with a rotating spreader plate and an adjustable opening. These wheeled applicators can cover a large area quickly but are known to provide uneven distribution. Because the distribution width is driven by ground speed, too little material will be distributed if the user walks too fast, and too much material will be distributed if the user walks too slowly. Additionally, coarse materials often clog the rotating spreader plate and cause damage to the device.

An additional exemplary traditional distributor is a handheld applicator. These applicators typically have sub-optimal ergonomics and can be difficult for many users to utilize. In some cases, handheld applicators are battery operated, but the battery outputs are typically weak power, and the batteries require frequent recharging. Further, these devices often have traditional rotor plates that are easily clogged and can break when distributing granular products.

The systems, methods, and devices described herein improve upon the deficiencies known in wheeled applicators and traditional handheld applicators. A granular distributor described herein includes a blower to ensure easy, efficient, and even distribution of granular products.

In the following description of the disclosure, reference is made to the accompanying drawings, which form a part hereof, and in which is shown by way of illustration specific implementations in which the disclosure may be practiced. It is understood that other implementations may be utilized, and structural changes may be made without departing from the scope of the disclosure.

Before the structures, systems, methods, and devices described herein are disclosed, it is to be understood that this disclosure is not limited to the particular structures, configurations, process steps, and materials disclosed herein as such structures, configurations, process steps, and materials may vary somewhat. It is also to be understood that the terminology employed herein is used for the purpose of describing particular embodiments only and is not intended to be limiting since the scope of the disclosure will be limited only by the appended claims and equivalents thereof.

In describing and claiming the subject matter of the disclosure, the following terminology will be used in accordance with the definitions set out below.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element, step, or ingredient not specified in the claim.

As used herein, the phrase “consisting essentially of” and grammatical equivalents thereof limit the scope of a claim to the specified ingredients, materials, or steps and those that do not materially affect the basic and novel characteristic or characteristics of the claimed disclosure.

Unless defined otherwise, all technical and scientific terms used herein have the same meanings as commonly understood by one of ordinary skill in the art to which this disclosure pertains and belongs.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to particular embodiments are not restricted to only those embodiments in which they are described. For example, an element described in reference to one embodiment or figure, may be alternatively included in another embodiment or figure regardless of whether or not those elements are shown or described in another embodiment or figure. In other words, elements in the figures may be interchangeable between various embodiments disclosed herein, whether shown or not.

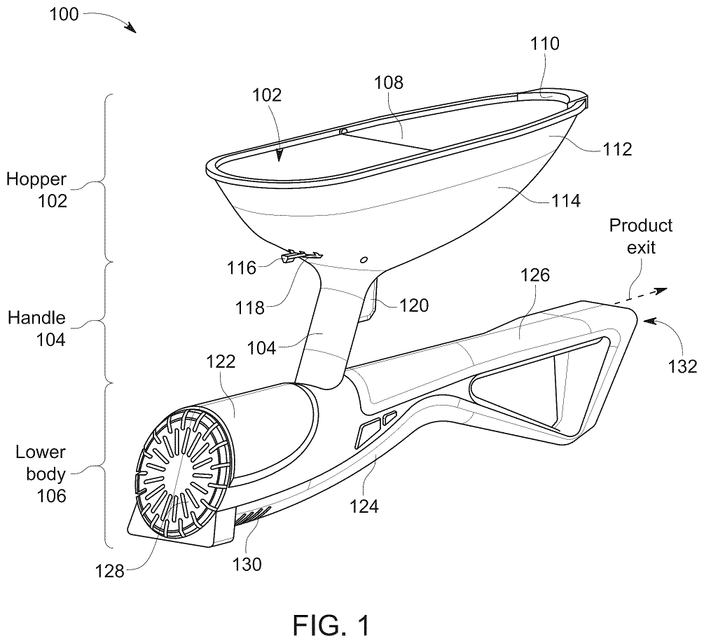

Referring now to the figures, FIG. 1 is a rear perspective view of a device 100 for distribution of granular products. The device 100 may specifically be utilized to evenly distribute a granular product such as fertilizer, ice melt, seeds, turf infill, pesticides, herbicides, salts, small rocks, dirt, sand, and so forth. The device ensures the granular product is distributed efficiently and evenly without significant effort from the user.

The device 100 includes three primary portions, including a hopper 102, handle 104, and lower body 106. The granular product is initially placed within the hopper 102. During use, the granular product will pass through the handle 104 and lower body 106, and then ultimately be disbursed through an exit hole. The device includes the hopper 102, which forms a concave container or bowl for holding the granular product. It should be appreciated that the hopper 102 may be configured to hold any amount of granular product. In an implementation, the hopper 102 is capable of holding 15 pounds of granular product. The hopper 102 is constructed of one or more sidewalls forming the concave or bowl shape. The device 102 includes a hopper lid 108 configured to cover the open top of the hopper 102 and thus prevent granular products from inadvertently spilling out of the hopper 102. The hopper lid 108 may form an airtight seal with the hopper 102. The hopper lid 108 may be composed of a flexible material such as rubber or plastic. In an implementation, the hopper lid 108 may have a groove formed around the perimeter or a portion of the perimeter of the hopper lid 108. The hopper 102 may have a lip configured to engage or interface with the groove of the hopper lid 108 to form a seal such as an airtight seal when the hopper lid 108 is in the closed position.

The hopper lid 108 may slide back and forth and/or rotate about a rotational point. For example, the hopper lid 108 may cover only a portion of the top surface of the hopper 102 and a plane of the hopper lid 108 may be substantially in the same plane as the other portion of the top surface of the hopper 102. Thus, the hopper lid 108 may slide or retract to open. In an implementation, the hopper lid 108 hinges to open. The hinge may be located at the rotational point. The hopper lid 108 may include a protrusion and the hopper 102 may include a recessed portion to receive the protrusion such that when the hopper lid 108 is opened the protrusion may be securely or snuggly fit into the recessed portion to keep the hopper lid 108 in the opened positioned. The protrusion and the recessed portion may be described as mating or positive and negative surfaces. The protrusion and the recessed portion may be formed into any shape such as the shape of a logo.

The hopper lid 108 may be configured to be easily removable to enable users to fill the hopper 102 and adjust mechanisms disposed within the hopper 102. The hopper lid 108 may be completely removable from the hopper 102 or may be partially attached to the hopper 102 when in the open position. In an implementation, the hopper lid 108 includes a handle 110 configured to interface with a user to allow the user to easily open the hopper lid 108. The hopper 102 may be constructed of a singular piece or may be constructed of multiple pieces. In the example illustrated in FIG. 1, the hopper 102 includes a hopper bottom 114 and a hopper top 112 that is attached to the hopper bottom 114. In an implementation, the hopper 102 or a portion of the hopper 102 and/or the hopper lid 108 or a portion of the hopper lid 108 are composed of a transparent, clear or semitransparent material such that a user may visually detect how much granular product is located in the hopper 102.

The device 100 includes a flowrate adjustor mechanism 116. The position of the flowrate adjustor mechanism 116 impacts the position of a flowrate adjustor plate (not visible in FIG. 1), and thereby impacts the flowrate of granular products exiting the hopper 102. The flowrate adjustor mechanism 116 may be in direct mechanical communication with the flowrate adjustor plate (not visible in FIG. 1) such that movement of the flowrate adjustor mechanism 116 causes movement of the flowrate adjustor plate. Alternatively, the flowrate adjustor mechanism 116 may be in indirect mechanical communication with the flowrate adjustor plate (not visible in FIG. 1) by providing a stopping point for the flowrate adjustor plate. In this case, the position of the flowrate adjustor mechanism 116 determines the maximum range of movement for the flowrate adjustor plate and thereby impacts the maximum flow rate of granular product exiting the hopper 102. In an implementation, the flowrate adjustor mechanism 116 may be described as a sliding mechanism as opposed to a variable adjusting knob. In an implementation, the flowrate adjustor mechanism 116 is a variable adjusting knob.

The sidewall of the hopper 102 includes an adjustor channel 118 disposed therethrough. The flowrate adjustor mechanism 116 is disposed within the adjustor channel 118 and can be slid back and forth along the adjustor channel 118. The flowrate adjustor mechanism 116 may be optimized such that the flowrate of granular products exiting the hopper 102 is minimized when the flowrate adjustor mechanism 116 is slid to the left side of the adjustor channel 118, and then maximized when the flowrate adjustor mechanism 116 is slid to the right side of the adjustor channel 118. It should be appreciated that the size and direction of the adjustor channel 118, and the movement of the flowrate adjustor mechanism 116, may be altered without departing from the scope of the disclosure. In an implementation, the adjustor channel 118 has defined or discrete positions for the flowrate adjustor mechanism 116. For example, the adjustor channel may have 5 positions or any other number of positions for the flowrate adjustor mechanism 116 to be placed into. The positions may be recesses that the sliding mechanisms of the flowrate adjustor mechanism 116 may be placed into. A portion of the flowrate adjustor mechanism 116 may be flexible to allow the flowrate adjustor mechanism 116 to be lifted or flexed into and out of a position. In an implementation, the adjustor channel 118 does not have positions and instead the flowrate adjustor mechanism 116 may be placed or slid into any position within the adjustor channel which may be described as continuous adjustment.

The device 100 includes the handle 104 portion attached to the hopper 102 portion. The sidewall of the hopper 102 includes a hopper exit hole (not visible in FIG. 1) disposed therethrough. Additionally, the sidewall of the handle 104 (and/or the sidewall of a tube disposed within the handle 104) forms a handle interior space. The sidewall of the handle 104 is attached to the sidewall of the hopper 102 such that the handle interior space is in airflow communication with the hopper exit hole. This ensures that granular products may pass through the hopper exit hole and move directly into the handle interior space.

The handle 104 is designed ergonomically to ensure it is easy and comfortable to be held by a human user. In an implementation, the lower body 106 has a length and the handle 104 is formed at an angle to the length of the lower body 106 that is optimal for ergonomics. For example, the angle of the handle 104 relative to the length of the lower body may be 65 degrees. The sidewall of the handle 104 includes a trigger channel (not visible in FIG. 1) disposed therethrough. The trigger channel is configured to receive a trigger 120 and enable the trigger 120 to be depressed inward toward the interior space of the handle 104. In its default position, the trigger 120 extends outward relative to the sidewall of the handle 104. The trigger 120 has a length that is at an angle relative to the length of the lower body 106. In an implementation, the length of the trigger 120 is formed at an angle of 90 degrees relative to the length of the lower body 106. In an implementation, the trigger 120 has a concave or curved surface configured to interface with a finger of a user.

A user may depress the trigger 120 to permit granular products to exit the device 100. The trigger 120 is in mechanical communication with the flowrate adjustor plate (not visible in FIG. 1). When the trigger 120 is depressed by a user, a hole is formed in between the hopper 102 and the handle 104. This hole permits granular products to pass through the hopper exit hole and into the handle interior space. The size of the hole, and thus the flowrate, is determined by the position of the flowrate adjustor mechanism 116. After gravity causes the granular product to fall through the handle interior space, the granular products may then be blown out of the device 100 with a blower.

The device 100 includes the lower body 106 portion attached to the handle 104 portion. The lower body 106 includes a blower housing 122, battery housing 124, and exit tube housing 126. The lower body 106 additionally includes a blower vent 128 that comprises a plurality of holes to allow fresh air to enter into the interior space of the blower housing 122. The lower body 106 additionally includes a cooling vent 130 that comprises a plurality of holes to enable hot air to exit the interior space of the lower body 106, and additionally enable ambient air to enter the interior space of the lower body 106. The lower body 106 additionally includes an exit hole 132, which is not visible in the view illustrated in FIG. 1.

The device 100 includes an exit tube (not visible in FIG. 1) disposed within the exit tube housing 126. The exit tube comprises a sidewall defining a hollowing exit interior space. When a user pulls the trigger 120, granular products are permitted to exit the hopper 102 through the hopper exit hole and then pass through the handle interior space, and then pass into the exit tube. The granular products may then be forced out of the device 100 with a blower.

The device 100 includes a blower (not visible in FIG. 1) disposed within the blower housing 122. The blower may include one or more of a fan, air compressor, air pump, air cannon, pre-compressed air, air cartridge, air chamber for compressed air, or other suitable device. In an implementation, the blower may include one or more carbon dioxide (CO2) cartridges. The CO2 cartridges may be off the shelve and may be replaceable once all the gas has been expelled from the CO2 cartridges. In an implementation, the blower includes an air chamber for compressed air that can be recharged via an external air compressor or air tank via a port or junction on the device 100. The blower moves air to force the granular products to move through the exit tube (not visible in FIG. 1) and out through the exit hole 132.

The device 100 includes one or more batteries (not visible in FIG. 1) disposed within the battery housing 124. The batteries may be disposable and replaceable or may be rechargeable. It should be appreciated that any type of batteries may be employed and more than one battery in more than one location within the device 100 may be employed. In an implementation, the batteries are lithium rechargeable batteries that are rechargeable via a port in the battery housing 124. The port may be covered by a weather proof cover that may be a flexible cover that is removable and may be composed of a material such as rubber. The batteries are in electrical communication with the blower. The batteries may additionally be in electrical communication with an agitator motor (not visible in FIG. 1) that breaks up clumps of granular products disposed within the hopper 102.

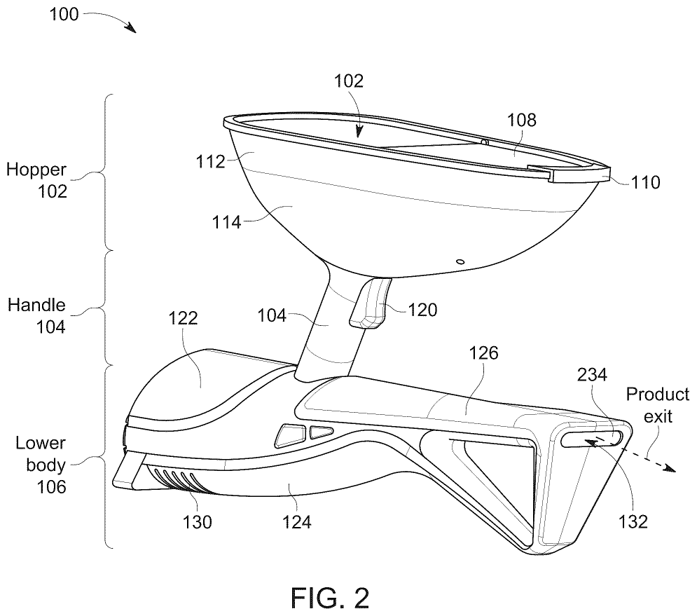

FIG. 2 is a front perspective view of the device 100 for distributing granular products. The exit hole 132 is visible in FIG. 2 and shows where the granular products exit the device 100 to be evenly dispersed. Additionally, a portion of an interior wall of the exit tube 234 is visible in FIG. 2. As discussed with respect to FIG. 1, the device includes an exit tube 234 disposed within the exit tube housing 126. The exit tube 234 comprises a sidewall that defines a hollow exit interior space. The granular products exit the device at the distal end of the exit tube 234, which comprises the exit hole 132.

The exit tube 234 may comprise varying cross-sectional geometries depending on the implementation. In the example illustrated in FIG. 2, the exit tube 234 comprises a rounded corner rectangular cross-sectional geometry. However, the exit tube 234 may comprise an oval, circular, rectangular, rounded square, square, pentagonal, or other cross-sectional geometry. The area of the cross-section of the exit tube 234 may vary along a total length of the tube. In some cases, the area of the cross-section is larger at a proximal end of the exit tube 234 (i.e., at an end nearest the handle 104) when compared with the area of the cross-section at the distal end of the exit tube 234 (i.e., at an end nearest the exit hole 132). The size of the exit tube 234 is optimized to ensure that granular products may pass through the exit tube 234 and out through the exit hole 132. In an implementation, the exit tube 234 may be composed of a flexible material.

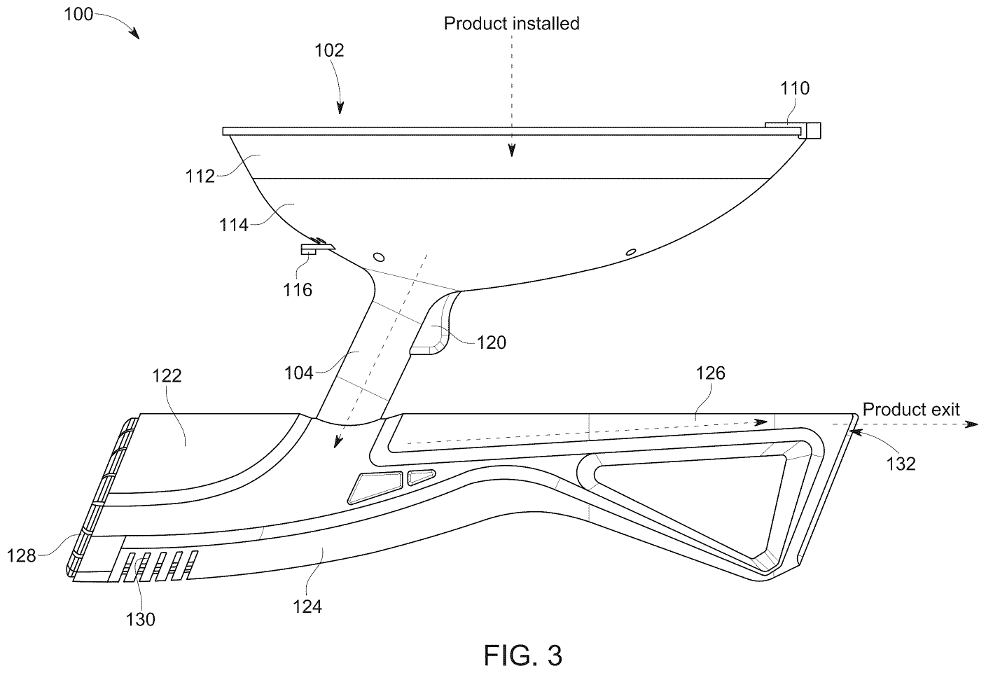

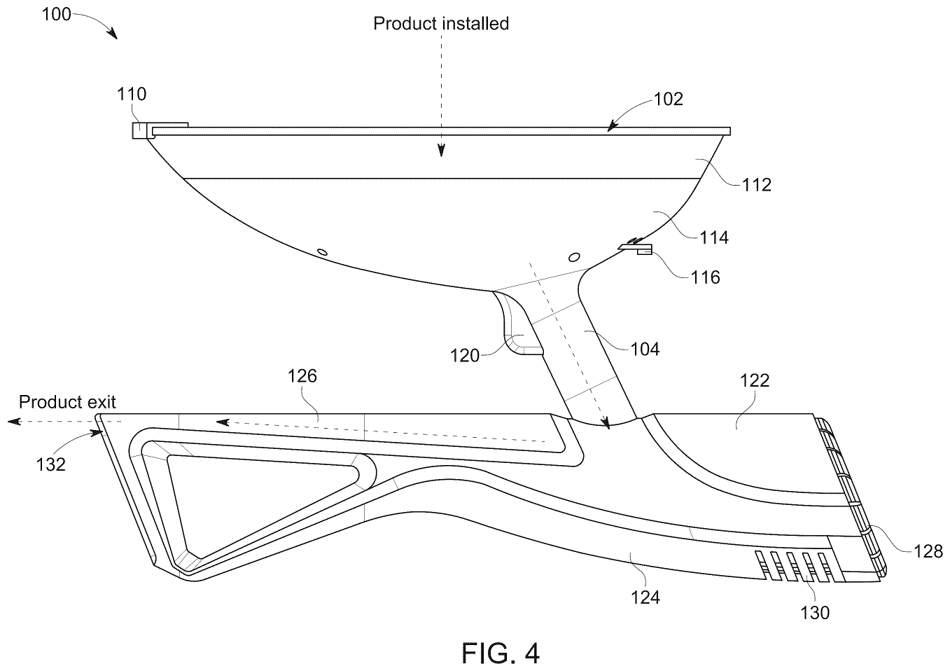

FIGS. 3 and 4 are opposite side views of the device 100 for distributing granular products. FIGS. 3 and 4 additionally include dotted arrowed lines illustrating the direction of travel of granular products through the interior of the device 100. As shown, granular products are installed in the device by disposing the granular products within the bowl formed by the hopper 102. The maximum flow rate of the granular products exiting the hopper 102 is determined by the position of the flowrate adjustor mechanism 116. The granular products are permitted to exit the hopper 102 when a user depressed the trigger 120. Gravity then causes the granular products to exit the hopper 102 and pass into an interior space defined by the handle 104, and then pass into an exit tube disposed within the lower body. When the blower is actuated, the granular product is forced to exit the device out through the exit hole 132. In an implementation, partially depressing or pulling the trigger may control an opening or size of an opening in which the granular product passes through. Thus, partially pulling the trigger may control a rate of flow of the granular product exiting the device 100. In an implementation, the trigger 120 is binary meaning that the trigger is either pulled in the “on” position or the trigger is off. Such a binary trigger may have the advantage of not allowing the trigger 120 to affect the flowrate and therefore only allow the flowrate adjustor mechanism 116 and/or blower to control the rate of flow.

In an implementation, the components of the device 100 are positioned within the device 100 to balance the device 100. For example, the device 100 may be balanced about a point centered in the handle 104. The device 100 may be balanced accounting for the weight of the granular product placed in the hopper 102. For example, heavier components such as the blower, the battery, motors, and/or fans, may be positioned within device 100 to offset the weight of a full load of granular product in the hopper 102.

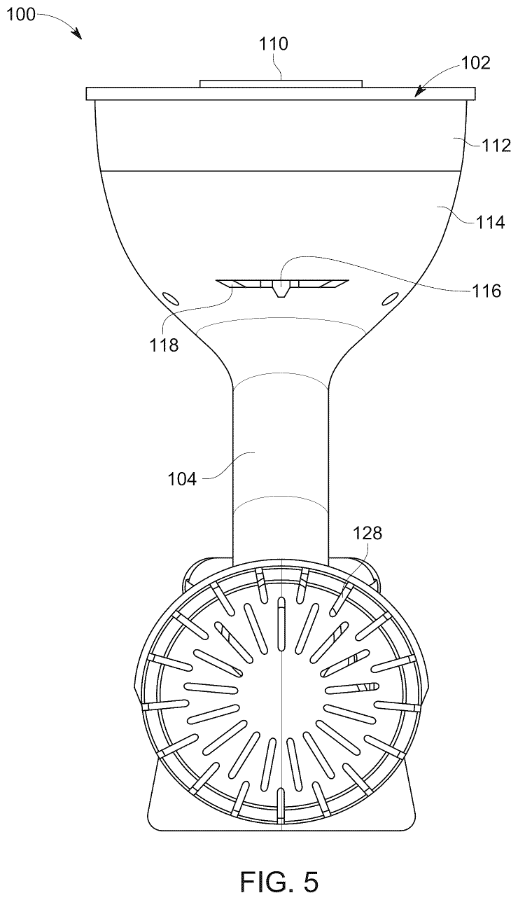

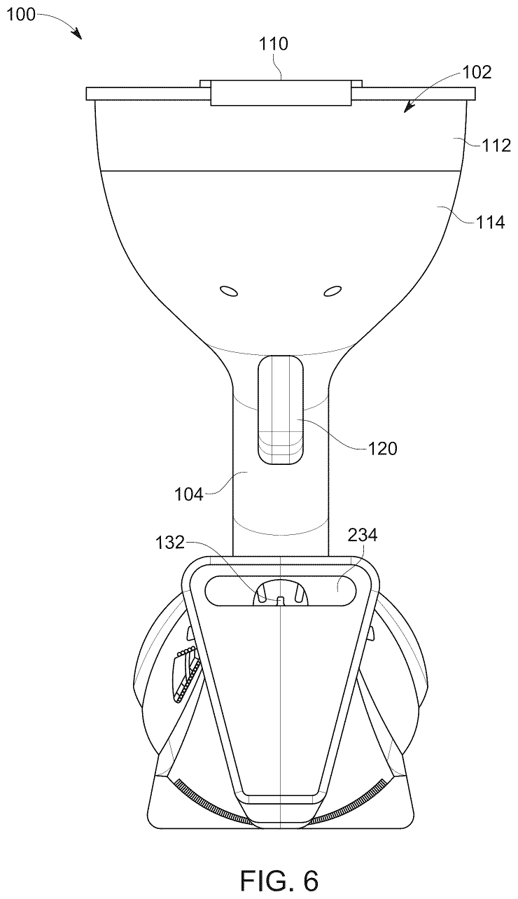

FIGS. 5 and 6 are end views of the device 100 for distributing granular products. FIG. 5 is a rear end view of the device 100, which specifically illustrates the blower vent 114. FIG. 6 is a front end view of the device 100, which specifically illustrates the exit hole 132.

FIG. 5 provides a view of the adjustor channel 118, which aids in utilizing the flowrate adjustor mechanism 116 to indicate how much granular product should be dispersed through the exit hole (see 132) at a time. The adjustor channel 118 may include a hole cut through a sidewall of the hopper 102 as shown in FIG. 5. The device 100 may additionally include numbers or other markings printed on to or cut into the sidewall of the hopper 102 as shown in FIG. 5. These markings aid a user in determining where the flowrate adjustor mechanism 116 should be placed to select a granular product disbursement rate.

In an example illustrated in FIG. 5, the device 100 includes adjustment markings from one through five. When the flowrate adjustor mechanism 116 is disposed near the “one” marking, then the device 100 will disburse a minimum amount of granular product at a time. When the flowrate adjustor mechanism 116 is disposed near the “five” marking, then the device 100 will disburse a maximum amount of granular product at a time. It should be appreciated that varying adjustment markings may be utilized depending on the use-case. In the example illustrated in FIG. 5, the flowrate adjustor mechanism 116 is located near the “three” marking to provide medium flowrate.

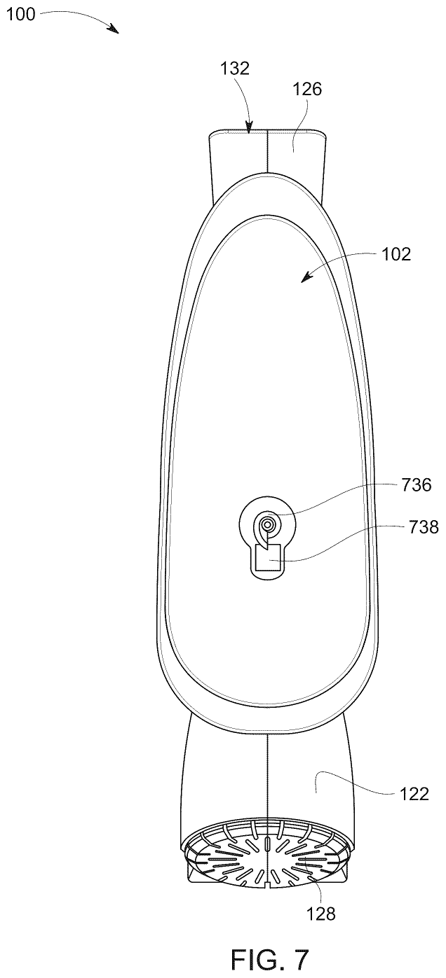

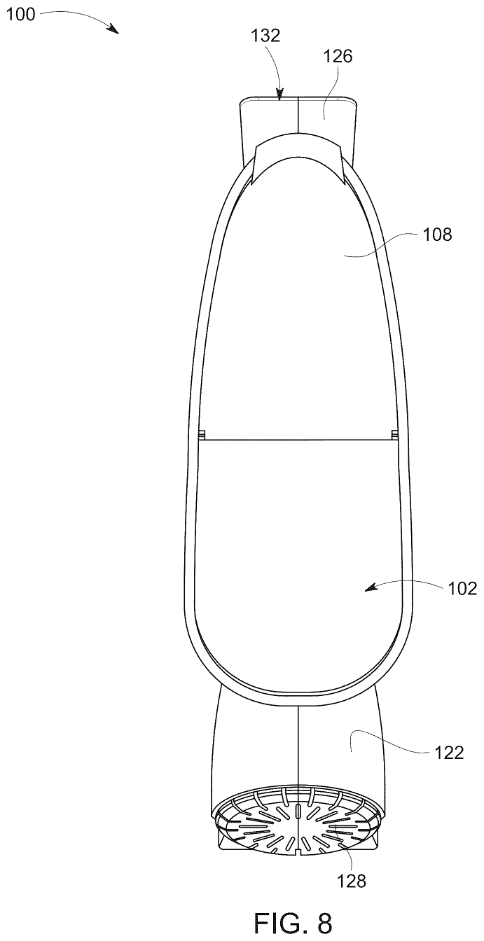

FIGS. 7 and 8 are aerial top-down views of the device 100 for disbursing granular products. FIG. 7 illustrates a top-down view wherein the hopper lid 108 has been removed. FIG. 8 illustrates a top-down view wherein the hopper lid 108 is in place.

As shown in FIG. 7, the device 100 includes a hopper exit hole 738 cut into the sidewall of the hopper 102 at a bottom of the hopper 102. The sidewall of the hopper 102 may be sloped such that gravity feeds the granular products toward the hopper exit hole 738.

The device 100 may additionally include a product agitator 736. The product agitator 736 is configured to agitate the granular products disposed within the hopper 102 and break up any potential clumps or oversized portions of the granular product. The device 100 includes an agitator motor (not visible in FIG. 7) that is in mechanical communication with the product agitator 736. The agitator motor causes the product agitator 736 to rotate. The agitator motor may cause the product agitator 736 to rotate at a steady or variable rate. In some cases, a user may alter the rotation rate of the product agitator 736 to suit the needs of the type or granular product that is being dispensed. The agitator motor may control the speed or rotation rate of the product agitator 736 and a user may control the agitator motor via a variable knob located on the exterior of the device 100 where the variable knob adjusts the amount of electricity going to the agitator motor.

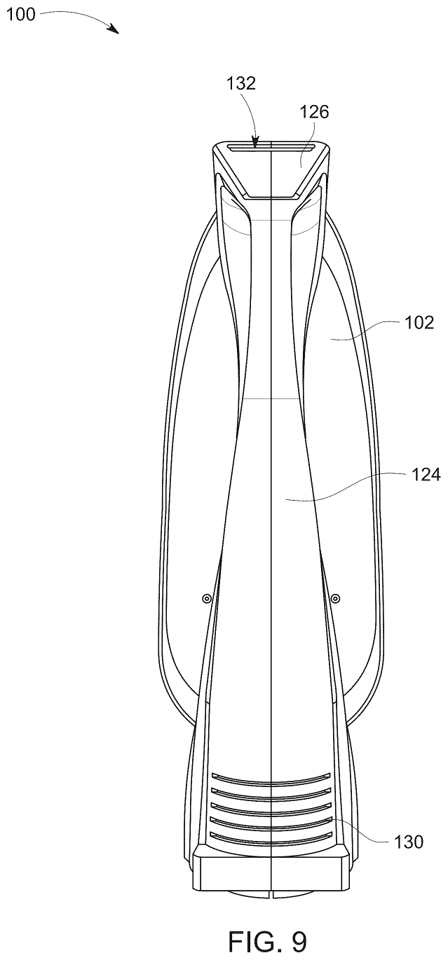

FIG. 9 is a bottom-up view of an underside of the device 100 for disbursing granular products. As shown in FIG. 9, the cross-sectional area of the lower body housing components may decrease in size when moving from the blower side to the product exit side. This may mirror the gradual decrease in size of the cross-sectional area of the exit tube (not visible). This may ensure that granular products are evenly disbursed through the exit hole 132.

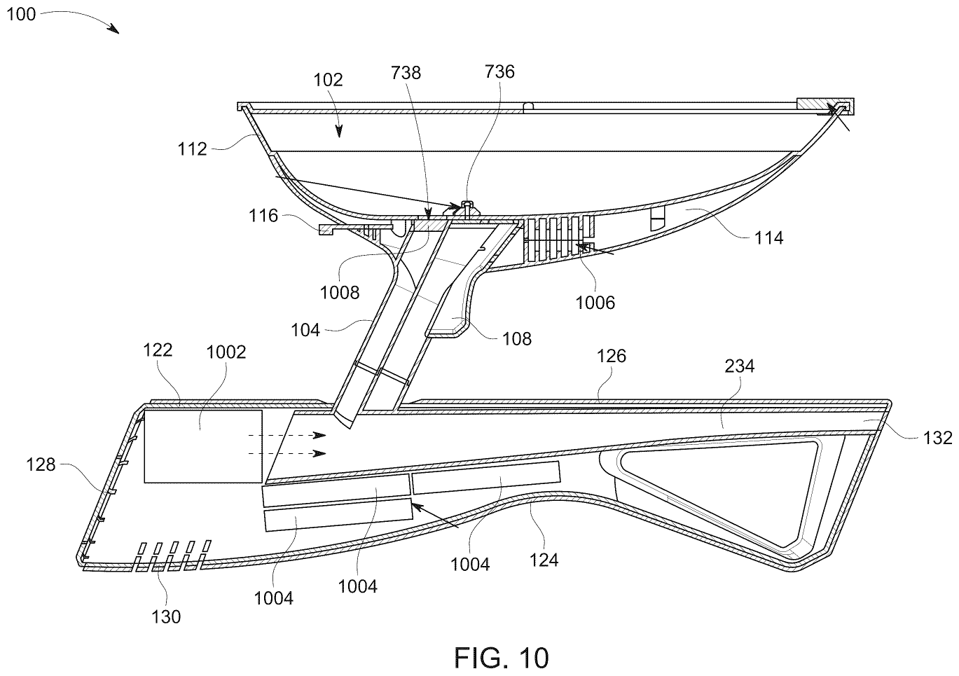

FIG. 10 is a cross-sectional side view of the device 100 for disbursing granular products. As shown in FIG. 10, the device 100 includes a blower 1002 disposed within the blower housing 122. The device 100 additionally includes an agitator motor 1006 disposed within the hopper bottom 114. The agitator motor 1006 is in electrical communication with the product agitator 736 and causes the product agitator 736 to rotate to break up clumps or larger granules disposed within the hopper 102. The device 100 additionally includes one or more batteries 1004 disposed within the battery housing 124. The batteries 1004 are in electrical communication with the blower 1002 and the agitator motor 1006. The device 100 additionally includes a flowrate adjustor plate 1008 that slides back and forth to adjust the maximum volume of granule product that is permitted to pass through the hopper exit hole 738 and enter the interior space of the handle 104.

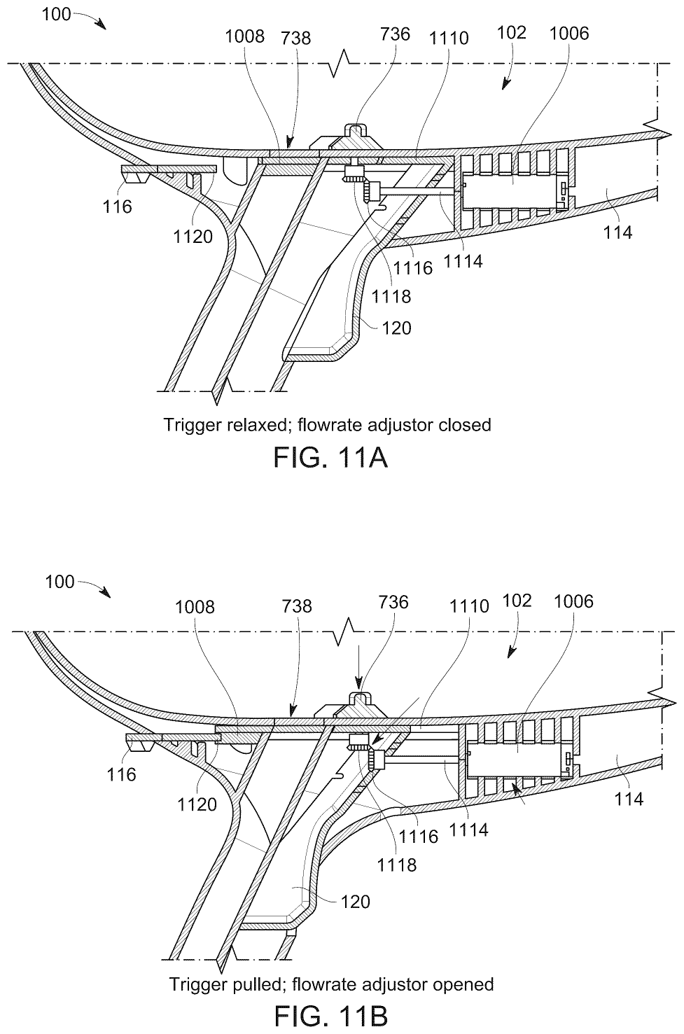

FIGS. 11A and 11B are cross-sectional side views of a portion of the device 100 for disbursing granular products. FIGS. 11A and 11B specifically illustrate operation of the system for product agitation, and the system for adjusting flowrate of granular products. FIG. 11A illustrates wherein the trigger is relaxed and the flowrate adjustor is closed such that granular products cannot pass through the hopper exit hole 738. FIG. 11B illustrates wherein the trigger is pulled and the flowrate adjustor is open such that granular products are permitted to pass through the hopper exit hole 738.

The system for product agitation includes at least the product agitator 736, the agitator motor 1006, the connecting rod 1114, the motor gear 1116, and the agitator gear 1118. The system for product agitation can be useful to ensure that granular products continue to flow through the hopper exit hole 738. Some granular products can become clumped or may be provided with larger pieces that cannot easily fit through the hopper exit hole 738. The product agitator 736 continuously rotates to reduce the presence of clumped granules and to ensure a continuous flow of granular product through the hopper exit hole 738.

The agitator motor 1006 may comprise its own battery power or may be in electrical communication with the batters (see 1004) disposed within the battery housing 124. The agitator motor 1006 causes rotation of the connecting rod 1114 which in turn causes rotation of the motor gear 1116. The motor gear 1116 is coupled to the agitator gear 1118 such that rotation of the connecting rod 1114 ultimately causes rotation of the product agitator 736. The motor gear 1116 may be oriented 90 degrees to the agitator gear 1118. The motor gear 1116 and the agitator gear 1118 may be 45 degree gears.

Referring now to the system for adjusting flowrate, FIG. 11A illustrates wherein the trigger 120 is relaxed and flowrate through the hopper exit hole 738 is closed, and FIG. 11B illustrates wherein the trigger 120 is pulled and flowrate through the hopper exit hole 738 is open. When the flowrate adjustor is in the closed position as shown in FIG. 11A, the flowrate adjustor plate 1008 is disposed over or within the hopper exit hole 738. The flowrate adjustor plate 1008 thereby closes the hopper exit hole 738 and prevents any granules from passing through the hopper exit hole 738. When the flowrate adjustor is in the open position as shown in FIG. 11B, the flowrate adjustor plate 1008 is shifted to the side of the of the hopper exit hole 738 and thereby permits granules to pass through the hopper exit hole 738.

The system for adjusting flowrate is manually actuated by a user when the user pulls the trigger 120. The device 100 may additionally include a lock to ensure the trigger 120 is locked into the pull position. This eliminates the need for the user to constantly pull the trigger 120 when utilizing the device 100.

The trigger 120 is attached to a plate depressor 1110. The plate depressor 1110 is configured to press against the flowrate adjustor plate 1008 and thereby adjust the position of the flowrate adjustor plate 1008. In some cases, the plate depressor 1110 and the flowrate adjustor plate 1008 constitute a singular piece of material. The axis of the plate depressor 1110 is substantially parallel to the axis of the flowrate adjustor plate 1008 such that side-to-side movement of the plate depressor 1110 (i.e., back and forth along the longitudinal axis of the plate depressor 1110) similarly causes side-to-side movement of the flowrate adjustor plate 1008. As shown, an acute angle is formed between an axis of the trigger 120 and an axis of the plate depressor 1110.

The adjustor mechanism 116 comprises a stopper end 1120, which provides a stop position for movement of the flowrate adjustor plate 1008. The side-to-side location of the stopper end 1120 along the longitudinal axis of the plate depressor 1110 is adjusted when the adjustor mechanism 116 is slid back and forth within the adjustor channel (see 118). When the adjustor mechanism 116 is slid to a first side of the adjustor channel (see 118) that is designated for minimum flowrate, then the stopper end 1120 will be pressed inward and located nearer to the hopper exit hole 738. Conversely, when the adjustor mechanism 116 is slid to an opposite side of the adjustor channel (see 118) that is designated for maximum flowrate, then the stopper end 1120 will be retracted outward and located farther from the hopper exit hole 738.

When the trigger 120 is relaxed, as shown in FIG. 11A, the plate depressor 1110 and flowrate adjustor plate 1008 are located in the closed position as shown in FIG. 11A. In this closed position, the flowrate adjustor plate 1008 is not butted up against the stopper end 1120 of the adjustor mechanism 116.

Conversely, when the trigger 120 is pulled, as shown in FIG. 11B, the plate depressor 1110 moves toward the hopper exit hole 738 and the flowrate adjustor plate 1008 moves toward the stopper end 1120. The trigger 120 can continue to be pulled until the flowrate adjustor plate 1008 buts up against the stopper end 1120. At this point, a hole within the flowrate adjustor plate 1108 enables granules to pass through the hopper exit hole 738 at the desired flowrate, as determined based on the position of the adjustor mechanism 116. FIG. 11B illustrates wherein the trigger 120 is pulled until the flowrate adjustor plate 1008 buts up against the stopper end 1120. The stopper end 1120 thereby ensures the hole disposed within the flowrate adjustor plate 1008 is correctly positioned over or within the hopper exit hole 738, as determined based on the position of the adjustor mechanism 116.

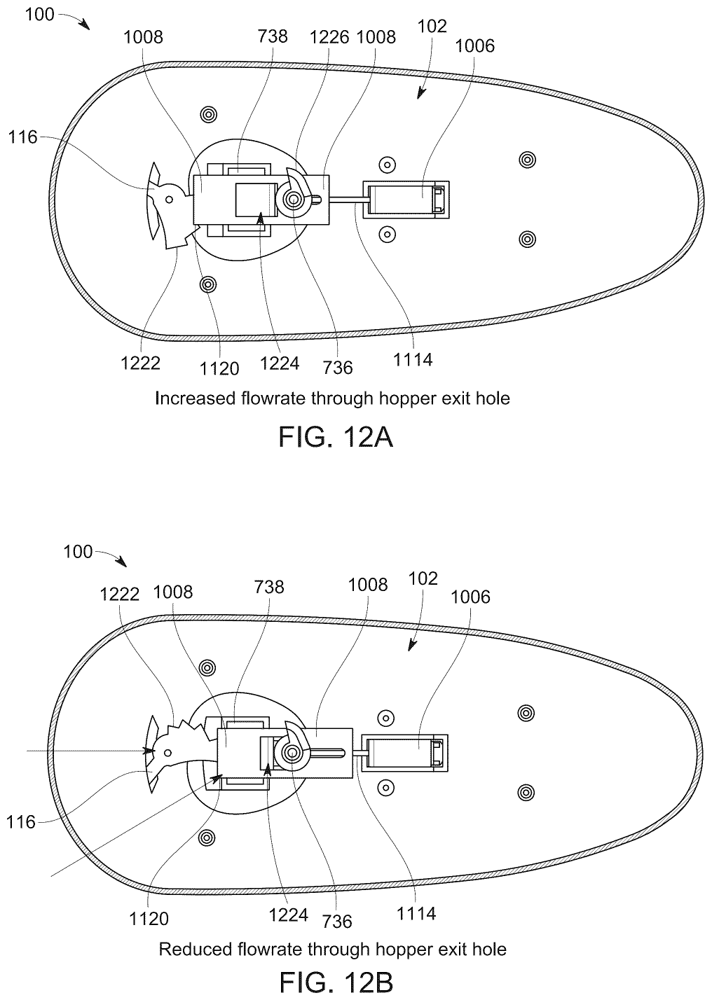

FIGS. 12A and 12B are top-down cross-sectional views of components of the device 100 for disbursing granular products. FIGS. 12A and 12B specifically illustrates components of the system for product agitation, and the system for adjusting flowrate of granular products. FIG. 12A illustrates wherein the adjustor mechanism 116 is set to enable increased flowrate through the hopper exit hole. FIG. 12B illustrates wherein the adjustor mechanism 116 is set to enable reduced flowrate through the hopper exit hole.

As shown in FIGS. 12A-12B, the flowrate adjustor plate 1008 comprises a flowrate hole 1224 disposed therethrough. The position of the flowrate hole 1224 over the hopper exit hole 738 determines the amount of granule product that is permitted to flow through the hopper exit hole 738. In FIG. 12A, a greater portion of the flowrate hole 1224 is positioned over the hopper exit hole 738, and thus, a greater volume of granule product is permitted to pass through the hopper exit hole 738. In FIG. 12B, a smaller portion of the flowrate hole 1224 is positioned over the hopper exit hole 738, and thus, a reduced volume of granule product is permitted to pass through the hopper exit hole 738.

The stopper end 1120 of the adjustor mechanism 116 is formed by a series of grooves 1222 in the adjustor mechanism. Each groove of the series of grooves 1222 marks one possible flowrate setting. In FIG. 12A, one of the more grooves of the series of grooves 1222 may be proximal grooves that serve as the stopper end 1120. This enables the flowrate adjustor plate 1008 to slide relatively far to the left and thus ensure a greater portion of the flowrate hole 1224 is aligned with the hopper exit hole 738. In FIG. 12B, one of the more grooves of the series of grooves 1222 may be distal grooves that serve as the stopper end 1120. This prevents the flowrate adjustor plate 1008 from sliding father to the left and thus prevents more of the flowrate hole 1224 from being aligned with the hopper exit hole 738.

Further as shown in FIGS. 12A-12B, the product agitator 736 comprises a wing 1226 that partially extends over the hopper exit hole 738 when the product agitator 736 is rotated by the agitator motor 1006. The wing 1226 helps ensure continuous movement of granular product through the hopper exit hole 738. It should be appreciated that that the wing 1226 may be configured to be any shape. In an implementation, the wing 1226 has a knife edge to encounter and break up clumps of granular product or large granular product. In an implementation, the wing 1226 is substantially circular with one or more protrusions. The protrusion may have a straight side and a curved side that meet at a point that extends radially from the center of the wing 1226, the curve surface may be an edged surface that has an edge like a knife blade. The wing 1226 may rotate in a direction such as clockwise that allows the curved knife edge to encounter the granular product. It should be appreciated that the device 100 and the components of the device 100 may have any shape or dimensions. The following are various implementations of dimensions that may be employed to form the device 100. In an implementation, an overall length of the device and the lower body 106 is 23.6 inches and the width is 3.5 inches. In an implementation, an overall length of the hopper 102 is 17.35 inches and the width is 6.5 inches. In an implementation, a height of the handle 104 and the hopper 102 is 8.54 inches. In an implementation, the height of the lower body 106 is 5 inches. In an implementation, to the blower housing 122 has the dimensions of 6×3×3 inches. In an implementation, the battery housing 124 has the dimensions 6.5×1.6×3 inches.

In an implementation, the device 100 does not include a rotary system to expel the granular product from the device 100 and instead relies upon forced air to expel the granular product from the device 100. In an implementation, the device 100 is a handheld portable device.

### Examples

The following examples pertain to further embodiments.

Example 1 is a device. The device includes a hopper comprising a hopper sidewall and a hopper exit hole, wherein the hopper exit hole is formed in the hopper sidewall. The device includes a flowrate adjustor plate, wherein a position of the flowrate adjustor plate relative to the hopper exit hole determines a flowrate of a product that exits the hopper. The device includes an exit tube comprising a tube sidewall and an exit hole disposed at a distal end of the exit tube, wherein the product passes through an exit interior space defined by the tube sidewall. The device includes a blower in airflow communication with the exit tube, wherein activation of the blower causes the product to be pushed through the exit tube and dispersed through the exit hole in the at the distal end of the exit tube.

Example 2 is a device as in Example 1, further comprising a handle attached to the hopper sidewall; wherein the handle comprises a handle sidewall forming a handle interior space; and wherein the handle interior space provides airflow communication between the hopper exit hole and the exit interior space of the exit tube.

Example 3 is a device as in any of Examples 1-2, wherein the handle sidewall is attached to the hopper sidewall.

Example 4 is a device as in any of Examples 1-3, wherein the handle interior space is disposed in between the hopper exit hole and the exit interior space of the exit tube; and wherein, in response to activating the blower, the product exits the hopper, and then travels through the handle interior space, and then travels through the exit interior space, prior to exiting through the exit hole.

Example 5 is a device as in any of Examples 1-4, wherein a longitudinal axis of the handle interior space forms an airflow angle relative to a longitudinal axis of the exit interior space; and wherein the airflow angle is from about 50° to about 85°.

Example 6 is a device as in any of Examples 1-5, further comprising: a product agitator disposed within the hopper; and a motor in mechanical communication with the product agitator; wherein the motor causes the product agitator to rotate.

Example 7 is a device as in any of Examples 1-6, wherein the product agitator is located substantially adjacent to the hopper exit hole.

Example 8 is a device as in any of Examples 1-7, wherein the product is a granular product, and wherein the product agitator rotates to reduce clumping in the granular product and thereby enable the granular product to exit the hopper.

Example 9 is a device as in any of Examples 1-8, further comprising an agitator rod providing the mechanical communication between the product agitator and the motor; wherein the flowrate adjustor plate comprises an adjustor channel disposed through the flowrate adjustor plate; and wherein the agitator rod is disposed through the adjustor channel.

Example 10 is a device as in any of Examples 1-9, further comprising an adjustor mechanism in mechanical communication with the flowrate adjustor plate; wherein movement of the adjustor mechanism causes movement of the flowrate adjustor plate.

Example 11 is a device as in any of Examples 1-10, wherein a user slides the adjustor mechanism to a first side to cause the flowrate adjustor plate to provide maximum blocking of the hopper exit hole and thus enable minimum flow rate of the product that exits the hopper; and wherein the user slides the adjustor mechanism to a second side that is opposite the first side, to cause the flowrate adjustor plate to provide minimum blocking of the hopper exit hole and thus enable maximum flow rate of the product that exits the hopper.

Example 12 is a device as in any of Examples 1-11, wherein the flowrate adjustor plate comprises a flowrate hole disposed therethrough; wherein a position of the flowrate hole relative to the hopper exit hole determines the flowrate of the product that exits the hopper.

Example 13 is a device as in any of Examples 1-12, further comprising a hopper lid, wherein the hopper lid pivots relative to a top opening of the hopper to enable a user to deposit the product into the hopper.

Example 14 is a device as in any of Examples 1-13, further comprising a lower body housing, wherein the lower body housing comprises: a blower vent comprising a plurality of holes to enable air to enter the blower; and a cooling vent comprising a plurality of holes to enable airflow into an interior space defined by the lower body housing; wherein the exit tube is disposed within the interior space defined by the lower body housing; and wherein a battery is disposed within the interior space defined by the lower body housing.

Example 15 is a device as in any of Examples 1-14, wherein the blower comprises a fan, wherein the fan is disposed within the interior space defined by the lower body housing.

Example 16 is a device as in any of Examples 1-15, wherein the blower comprises compressed gas.

Example 17 is a device as in any of Examples 1-16, wherein the blower comprises an air cannon.

Example 18 is a device as in any of Examples 1-17, wherein the product is a granular product.

Example 19 is a device as in any of Examples 1-18, wherein the product is one or more of a granular fertilizer, granular pesticide, granular herbicide, seeds, or turf infill.

Example 20 is a device as in any of Examples 1-19, wherein the product is a granular ice melt product.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments. For example, components described herein may be removed and other components added without departing from the scope or spirit of the embodiments disclosed herein or the appended claims.

Other embodiments will be apparent to those skilled in the art from consideration of the specification and practice of the disclosure disclosed herein. It is intended that the specification and examples be considered as exemplary only, with a true scope and spirit of the invention being indicated by the following claims.

What is claimed is:

1. A device comprising:
a hopper comprising a hopper sidewall and a hopper exit hole, wherein the hopper exit hole is formed in the hopper sidewall;
a flowrate adjustor plate, wherein a position of the flowrate adjustor plate relative to the hopper exit hole determines a flowrate of a product that exits the hopper;
an exit tube comprising a tube sidewall and an exit hole disposed at a distal end of the exit tube, wherein the product passes through an exit interior space defined by the tube sidewall; and
a blower in airflow communication with the exit tube;
wherein activation of the blower causes the product to be pushed through the exit tube and dispersed through the exit hole at the distal end of the exit tube.

2. The device of claim 1, further comprising a handle attached to the hopper sidewall;
wherein the handle comprises a handle sidewall forming a handle interior space; and
wherein the handle interior space provides airflow communication between the hopper exit hole and the exit interior space of the exit tube.

3. The device of claim 2, wherein the handle sidewall is attached to the hopper sidewall.

4. The device of claim 2, wherein the handle interior space is disposed in between the hopper exit hole and the exit interior space of the exit tube; and
wherein, in response to activating the blower, the product exits the hopper, and then travels through the handle interior space, and then travels through the exit interior space, prior to exiting through the exit hole.

5. The device of claim 2, wherein a longitudinal axis of the handle interior space forms an airflow angle relative to a longitudinal axis of the exit interior space; and
wherein the airflow angle is from about 50° to about 85°.

6. The device of claim 1, further comprising:
a product agitator disposed within the hopper; and
a motor in mechanical communication with the product agitator;
wherein the motor causes the product agitator to rotate.

7. The device of claim 6, wherein the product agitator is located substantially adjacent to the hopper exit hole.

8. The device of claim 6, wherein the product is a granular product, and wherein the product agitator rotates to reduce clumping in the granular product and thereby enable the granular product to exit the hopper.

9. The device of claim 6, further comprising an agitator rod providing the mechanical communication between the product agitator and the motor;
wherein the flowrate adjustor plate comprises an adjustor channel disposed through the flowrate adjustor plate; and
wherein the agitator rod is disposed through the adjustor channel.

10. The device of claim 1, further comprising an adjustor mechanism in mechanical communication with the flowrate adjustor plate;
wherein movement of the adjustor mechanism causes movement of the flowrate adjustor plate.

11. The device of claim 10, wherein a user slides the adjustor mechanism to a first side to cause the flowrate adjustor plate to provide maximum blocking of the hopper exit hole and thus enable minimum flow rate of the product that exits the hopper; and
wherein the user slides the adjustor mechanism to a second side that is opposite the first side, to cause the flowrate adjustor plate to provide minimum blocking of the hopper exit hole and thus enable maximum flow rate of the product that exits the hopper.

12. The device of claim 1, wherein the flowrate adjustor plate comprises a flowrate hole disposed therethrough;
wherein a position of the flowrate hole relative to the hopper exit hole determines the flowrate of the product that exits the hopper.

13. The device of claim 1, further comprising a hopper lid, wherein the hopper lid pivots relative to a top opening of the hopper to enable a user to deposit the product into the hopper.

14. The device of claim 1, further comprising a lower body housing, wherein the lower body housing comprises:
a blower vent comprising a plurality of holes to enable air to enter the blower; and
a cooling vent comprising a plurality of holes to enable airflow into an interior space defined by the lower body housing;
wherein the exit tube is disposed within the interior space defined by the lower body housing; and
wherein a battery is disposed within the interior space defined by the lower body housing.

15. The device of claim 14, wherein the blower comprises a fan, wherein the fan is disposed within the interior space defined by the lower body housing.

16. The device of claim 1, wherein the blower comprises compressed gas.

17. The device of claim 1, wherein the blower comprises an air cannon.

18. The device of claim 1, wherein the product is a granular product.

19. The device of claim 1, wherein the product is one or more of a granular fertilizer, granular pesticide, granular herbicide, seeds, or turf infill.

20. The device of claim 1, wherein the product is a granular ice melt product.
